(19) United States
(12) Patent Application Publication
(10) Pub. No.: US 2025/0156240 A1
(43) Pub. Date: May 15, 2025

(54) Smoothing Intra-Faas Workflow Variations Using Process-Subsumed Subflows

(71) Applicant: International Business Machines Corporation, Armonk, NY (US)

(72) Inventors: Padmanabha Venkatagiri Seshadri, Mysore (IN); Vijay Ekambaram, Chennai (IN); Subhajit Bhuiya, Bengaluru (IN); Saravanan Sadacharam, Chennai (IN)

(21) Appl. No.: 18/389,333

(22) Filed: Nov. 14, 2023

(51) Int. Cl. G06F 9/50

(52) U.S. Cl. CPC G06F 9/5077

(57) ABSTRACT

Mechanisms are provided for segregating a function-as-a-service (FaaS) workflow into processes for segregated execution. The mechanisms identify a plurality of sub-flows within the FaaS workflow. The mechanisms generate, for each sub-flow, a container to implement the sub-flow as a separate process from processes of other sub-flows in the FaaS workflow. At least one sub-flow comprises a plurality of functions of the FaaS workflow. In addition, the mechanisms deploy the containers of the plurality of sub-flows for execution by one or more nodes.

### BACKGROUND

The present application relates generally to an improved data processing apparatus and method and more specifically to an improved computing tool and improved computing tool operations/functionality for smoothing intra-function-as-a-service (FaaS) variations using process-subsumed sub-flows.

Function-as-a-Service (FaaS) is a type of cloud computing service that allows developers to build, compute, rune, and manage application packages as functions and execute code in response to events, without managing the complex infrastructure typically associated with building and launching microservice applications. FaaS is an event driven execution model that runs in stateless containers with management of server-side logic and state through the use of services from a FaaS provider.

Hosting a software application on the Internet typically requires provisioning and managing a virtual or physical server and managing an operating system and web server hosting processes. With FaaS, the physical hardware, virtual machine operating system, and web server software management are all handled automatically by the cloud service provider. This allows developers to focus solely on individual functions in their application code.

FaaS provides many benefits. With FaaS, a developer can divide the server into functions that can be scaled automatically and independently so that one does not have to manage infrastructure. This allows developers to focus on the application code and can dramatically reduce time-to-market. In addition, with FaaS, one pays only when an action occurs. When the action is complete, everything stops, i.e., no code runs, no server idles, no costs are incurred. Thus, FaaS is a cost-effective solution, especially for dynamic workloads or scheduled tasks. FaaS also offers a superior total-cost-of-ownership for high-load scenarios.

Moreover, with FaaS, functions are scaled automatically, independently, and instantaneously, as needed. When demand drops, FaaS automatically scales back down. Furthermore, FaaS offers inherent high availability because it is spread across multiple availability zones per geographic region and can be deployed across any number of regions without incremental costs.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for segregating a function-as-a-service (FaaS) workflow into processes for segregated execution. The method comprises identifying a plurality of sub-flows within the FaaS workflow. The method also comprises generating, for each sub-flow, a container to implement the sub-flow as a separate process from processes of other sub-flows in the FaaS workflow. At least one sub-flow comprises a plurality of functions of the FaaS workflow. In addition, the method comprises deploying the containers of the plurality of sub-flows for execution by one or more nodes.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a solution for performing function-as-a-service (FaaS) workflows in which each function is a separate process;

FIG. 2 is an example diagram of a solution for performing FaaS workflows in which all of the functions are packed into a single process;

FIG. 3 is an example diagram of a hybrid solution in accordance with one illustrative embodiment;

FIG. 4 is an example diagram illustrating an overall operation of a FaaS workflow system that performs smoothing of intra-FaaS variations using process-subsumed sub-flows in accordance with one illustrative embodiment;

FIG. 5 is an example diagram of a distributed data processing system environment in which aspects of the illustrative embodiments may be implemented and at least some of the computer code involved in performing the inventive methods may be executed;

FIG. 6 is a flowchart outlining an example operation of a workflow path segregation engine in accordance with one illustrative embodiment;

FIG. 7 is a flowchart outlining an example operation of a process and invocation apparatus design engine in accordance with one illustrative embodiment;

FIG. 8 is a flowchart outlining an example operation of a routing tap design engine in accordance with one illustrative embodiment;

FIG. 9 is a flowchart outlining an example operation of a deployment reconfiguration engine in accordance with one illustrative embodiment;

FIG. 10 is a flowchart outlining an example operation of FaaS workflow system in accordance with one illustrative embodiment;

FIG. 11A is an example depiction of a container for a sub-flow in accordance with one illustrative embodiment;

FIG. 11B is an example of a scenario handled by the inserted proxy in accordance with one illustrative embodiment;

FIG. 12A is a diagram showing an example in which the control paths flow through a junction in accordance with one illustrative embodiment;

FIG. 12B is a diagram showing an example in which control paths are determined as a result of the outcome of the processing performed by a function in accordance with one illustrative embodiment;

FIG. 13 is an example diagram illustrating the process of FIG. 8 for the example of a routing tap for a function invocation event, such as shown in FIG. 12A, in accordance with one illustrative embodiment;

FIG. 14 is an example diagram illustrating the process of FIG. 8 for the example of a routing tap for a function return event, such as shown in FIG. 12B, in accordance with one illustrative embodiment; and

FIG. 15 is an example diagram illustrating the operation of FIG. 9 with regard to the example FaaS workflow of FIG. 4, in accordance with one illustrative embodiment.

### DETAILED DESCRIPTION

The illustrative embodiments provide an improved computing tool and improved computing tool operations/functionality for smoothing intra-function-as-a-service (FaaS) variations using process-subsumed sub-flows. The illustrative embodiments are specifically directed to solving the issues of execution performance, e.g., stability and latency, and profiling performance of functions in sub-flows of FaaS workflows. In the following description, a container architecture is assumed, such as a Kubernetes® architecture, or the like. Thus, the following description will make reference to container architecture terminology, such as nodes, containers, and the like, and assumes a familiarity with this terminology.

FaaS workflows involve functions invoking other functions as part of the workflow, where each function can be individually containerized, scaled, and relocated across machines in a cloud-native environment. FaaS work units help with fine-grained billing and scaling so that the customer only pays for what the customer uses.

FaaS workflows are highly repetitive, getting executed thousands of times. It is important to be able to correctly profile the performance of such FaaS workflows in order to perform resource provisioning to avoid under-performance or resource wastage. Moreover, reducing latency variations improves forecasting request queues and provides improved provisioning for FaaS workflows. Thus, an additional goal is to be able to reduce variation as well as latency in forecasting request queues.

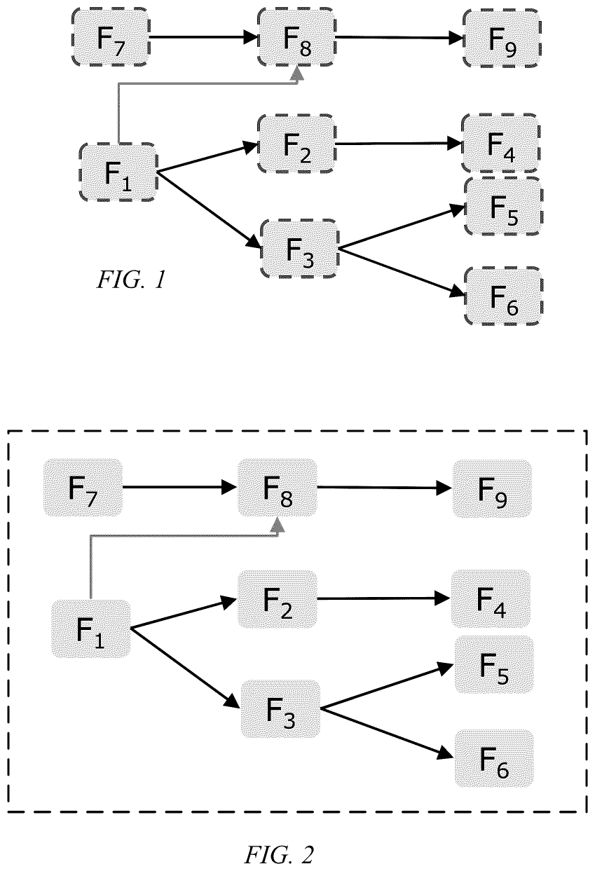

FaaS workflow solutions fall into two main categories. In a first FaaS workflow solution, as shown in FIG. 1, each function in the workflow is implemented as a separate process (represented by dashed lines) such that individual processes can be scaled and observed, where “observed” refers to the ability to identify, such as through logs, probes, and the like, the behavior of the function with regard to resources it is accessing, its performance, whether the function is behaving maliciously or operating properly, etc. As shown in FIG. 1, for a given FaaS workflow involving functions F1-F9, with the invocations as shown by the arrows in FIG. 1, each function F1-F9 is a separate process, meaning that each function F1-F9 executes as a separate procedure to achieve a result. While this allows for individual scaling and observation of the processes, this solution causes cross-node and/or cross-process delays, e.g., the results of one process must be passed to the next process in order for the next process to perform its operations in accordance with the FaaS workflow. That is, in a container based architecture, delays exist with regard to container orchestration processes, operating system overhead, and the like. In such an architecture, a node is a machine executing containers, e.g., a computing device, a processor, etc., and when a container on one machine has to call a container of another machine, this adds delays to the performance, which is referred to as cross-node delay. Even if the processes are all running on the same machine, or node, the operating system overhead is still present, which causes the cross-process delays.

In a second FaaS workflow solution, all the functions are packed into a single process, as shown in FIG. 2. As shown in FIG. 2, assuming a similar FaaS workflow as shown in FIG. 1, all of the functions F1-F9 are packed into the same process, meaning that all of the functions F1-F9 execute as part of a single procedure to generate a result. With this solution, cross-node and/or cross-process delays are eliminated as every function is in the same process sharing the same address space. However, this solution is bulky to replicate and causes over-provisioning of resources because of the coarseness, i.e., every function gets replicated every time as part of the process even if only a portion of the functions need to be executed. Moreover, individual functions are not observable, e.g., one cannot observe function F2 apart from the other functions F1 and F3-F9 of the process.

It would be beneficial to be able to have a hybrid of these two solutions to take advantage of the benefits of both solutions, yet minimize the negative aspects. The illustrative embodiments provide mechanisms to implement such a hybrid approach. In the hybrid solution of the illustrative embodiments, subsets of the functions, i.e., sub-flows, are combined into a process, but not all functions are combined into a single process. The subsets of the functions that are combined into the same process are those sequences of functions, in the FaaS workflow, that are determined to frequently occur together, e.g., a subset of functions of the FaaS workflow that are executed together in a sequence at least a threshold number of times. As the packing of functions into processes in this manner breaks invocations between the sequences, special routing taps are added that operate at junction points to intelligently control the flow of invocation of the functions. In addition, in-process proxies are added to further provide mechanisms for invocation of the functions. The packing of functions into processes may be performed dynamically as the invocation frequencies change over time, along with the insertion of routing taps and proxies, e.g., over time, based on gathered performance data, it may be determined that a different packing of functions into processes for the same FaaS workflow is warranted as invocation frequencies change.

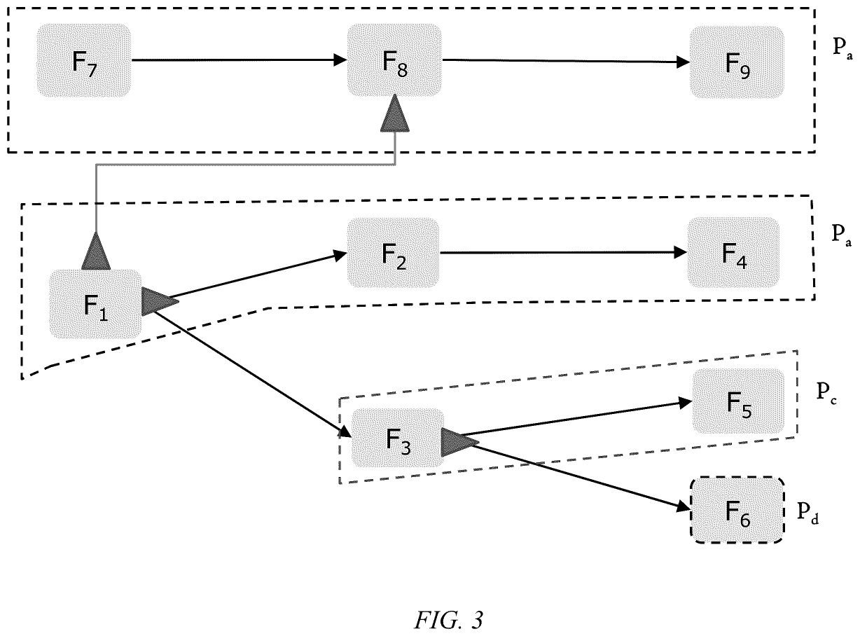

FIG. 3 is an example diagram illustrating an example hybrid packing of functions into processes in accordance with one illustrative embodiment. The example shown in FIG. 3 utilizes the same example FaaS workflow as shown in FIGS. 1 and 2, but in which sequences of function invocations, i.e., sub-flows, are packed into separate processes based on a determined frequency of occurrence of the various sequences. Thus, for example, suppose that the FaaS workflow, during peak hours of load, has the following frequently occurring function invocation sequences: F1-F2-F3, F7-F8-F9, and F3-F5 occurs more frequently that F3-F6. Using these heuristics, the functions may be segregated into separate sub-flows of the FaaS workflow, and packed into separate processes Pa, Pb, Pc, and Pd as shown in FIG. 3.

It should be appreciated that packing functions in this manner means that the invocations between F1-F8, F1-F3, F3-F6 are broken, unless special routing taps are inserted operating at junction points. These special routing taps intelligently control the flow of invocations. For example, depending on the output of F1, the routing tap can determine whether to move the control to F2 within the process Pb or outside the process Pb to F8 in process Pa. In addition, an in-process proxy within process Pa is provided that invokes the function F8 if it needs to follow function F1. Since these workflow path invocation frequencies change dynamically, the process packing may change over time. Thus, the packing of functions F1-F9 into processes, such as processes Pa—Pd or other processes in addition to or less than those shown, is performed dynamically or “on-the-fly”. Similarly, routing taps and proxies may also be inserted dynamically as needed by the particular packing of functions into processes.

By packing sub-flows into separate processes to segregate the FaaS workflow, workflow stability is improved and latency is reduced. That is, the hybrid approach of the illustrative embodiments achieves the beneficial results of the single process solution of FIG. 2 for each for each separate sub-flow, i.e., minimization of cross-node and/or cross-process delays, and the beneficial results of the separate process solution of FIG. 1 across the separate processes, i.e., scaling and observability. Because each function is packed with other functions in accordance with the frequency of occurrence, the drawbacks of the separate process solution of FIG. 1 are minimized, i.e., cross-node and/or cross-process delays are minimized, while minimizing the bulkiness and overprovisioning issues of the single process solution of FIG. 3.

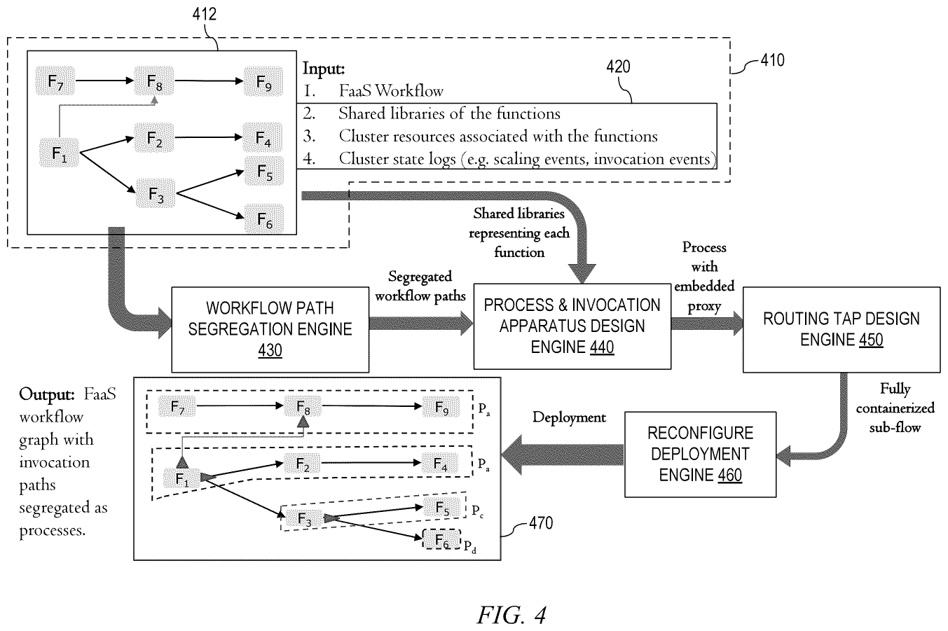

FIG. 4 is an example diagram illustrating an overall operation of a FaaS workflow system that performs smoothing of intra-FaaS variations using process-subsumed sub-flows in accordance with one illustrative embodiment. The operational components shown in FIG. 4 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., FaaS workflows and other input data, and outputs may be beneficial to human beings. The invention is specifically directed to the automatically operating computer components directed to improving the way that FaaS workflows are executed, and providing a specific solution that implements FaaS workflow segmentation into sub-flows, generation of processes with inserted proxies and routing taps based on the segmentation, and reconfiguring of deployment of the FaaS workflow, which cannot be practically performed by human beings as a mental process and is not directed to organizing any human activity.

As shown in FIG. 4, the operation assumes that there is a predefined FaaS workflow 410 that is provided as input along with data 420 specifying the shared libraries of the functions of the FaaS workflow 410, cluster (group of nodes) resources associated with the functions of the FaaS workflow 410, and cluster state logs, e.g., scaling events, invocation events, etc. When a FaaS workflow 410 is submitted, the data 420 is also submitted along with a FaaS workflow graph 412, as shown in FIG. 4. The FaaS workflow 410 is input to a workflow path segregation engine 430 of the FaaS workflow system 400. The workflow path segregation engine 430 generates segregated workflow paths based on the frequency of occurrence of sequences of function invocations, as determined from the cluster state logs. The segregated workflows are referred to herein as sub-flows, where each sub-flow comprises a subset of the functions of the FaaS workflow 410 which are determined to be frequently occurring sequences of function invocations. Thus, the workflow path segregation engine 430 operates to identify sub-flows that re candidates for subsuming under process abstraction. This may be achieved, for example, through greedy packing algorithms, as well as heuristics such as past scaling patterns of the individual function invocations.

The segregated workflow paths, i.e., the segregated sub-flows, are input to a process and invocation apparatus design engine 440. The process and invocation apparatus design engine 440 operates on the segregated workflow paths along with shared libraries representing each function of the FaaS workflow 410 as obtained from the data 420, to generate processes for each of the segregated sub-flows with embedded proxies for functions that are invoked from functions in separate sub-flows, i.e., cross-process invocations. The corresponding shared libraries for the functions of a sub-flow are packaged together into a binary along with the “jump-in” proxies which have a configurable policy.

These processes with the embedded proxies are then provided to the routing tap design engine 450. The routing tap design engine 450 inserts routing taps into the functions of the processes that invoke functions in different processes. That is, the routing tap design engine 450 analyzes the separate processes of the segregated FaaS workflow and identifies first functions that invoke second functions in different processes than the first processes. For each of these first processes, a routing tap is inserted that comprises logic for determining when to route invocations to functions in separate processes or to continue the invocation within the same process. These routing taps are software instructions that are executed to make such routing decisions based on the results generated by the function with which the routing tap is associated.

In some illustrative embodiments, the routing taps may be Extended Berkeley Packet Filters (eBPF) routing taps. eBPFs are verified modules which can be inserted dynamically into an operating system kernel, such as a Linux kernel. This framework is useful in observability, high-performance networking and security of applications. eBPFs are executed in a sandbox manner with the module having access to some operating system privileges. The eBPFs allow probes, both kernel probes on system calls and user space probes on functions or applications, where user space refers to the unprivileged portion of memory that has to request the operating system to perform certain functions through system calls. In the illustrative embodiments, the eBPF routing taps leverage cluster state and function dynamic properties, to dynamically control the sub-flows within the processes, where these routing taps work with proxies associated with functions in other processes to implement cross-process function invocations.

In order to insert the eBPF routing taps, the functions with which the eBPF routing taps are inserted, are wrapped up with augmented signatures which contain the original function signature and control-flow-flags, as well as augmented return variables which contain the return values and the control-flow-flags. The control-flow-flags may be set through dynamically attached probes which get invoked either during function invocation or before the function return of the augmented return variables. The probes alter the control-flow-flags in accordance with a user defined policy to alter the ongoing workflow following the function invocation.

Thus, the output of the routing tap design engine 450 is a segregated FaaS workflow having fully containerized sub-flows with inserted proxies and routing taps where appropriate. The output of the routing tap design engine 450 is provided to the reconfigure deployment engine 460 which generates a deployment plan for the segregated FaaS workflow 470. Thus, the resulting deployment plan 480 comprises a FaaS workflow graph with invocation paths segregated as processes and control data specifying how to deploy the different processes for execution. The reconfiguring of the deployment may involve deploying the containers, generated as a result of the operations of the other elements of the FaaS workflow engine 400, with associated reconfiguration of the platform entities, such as the volumes and ingress/service resources associated with the container. These reconfigurations inherit the original cluster resource definitions associated with the functions and rationalize them to be compatible with the contents of the corresponding processes.

Thus, the illustrative embodiments provide an improved computing tool and improved computing tool operations/functionality that specifically improves the way in which FaaS workflows are deployed and executed so as to improve stability and latency in the FaaS workflow execution as well as promote observability of the functions of each of the sub-flows in the FaaS workflow. The illustrative embodiments segment the FaaS workflow into sub-flows and packs the sub-flows into separate processes. Inter-process function invocations are handled through the insertion of appropriate routing taps and proxies to determine routing through the FaaS workflow at intersection points. The illustrative embodiments make the FaaS workflow executable using a hybrid approach to packing the functions of the FaaS workflow into processes for stable (reduced variation) and reduced latency execution.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides a function-as-a-service (FaaS) workflow system that implements a hybrid approach to function segmentation and process packing. The improved computing tool implements mechanism and functionality, such as the FaaS workflow system, which cannot be practically performed by human beings either outside of, or with the assistance of, a technical environment, such as a mental process or the like. The improved computing tool provides a practical application of the methodology at least in that the improved computing tool is able to segment a FaaS workflow into sub-flows and pack the sub-flows into processes using inserted routing taps and proxies, so as to implement a hybrid approach to execution of the functions of the FaaS workflow.

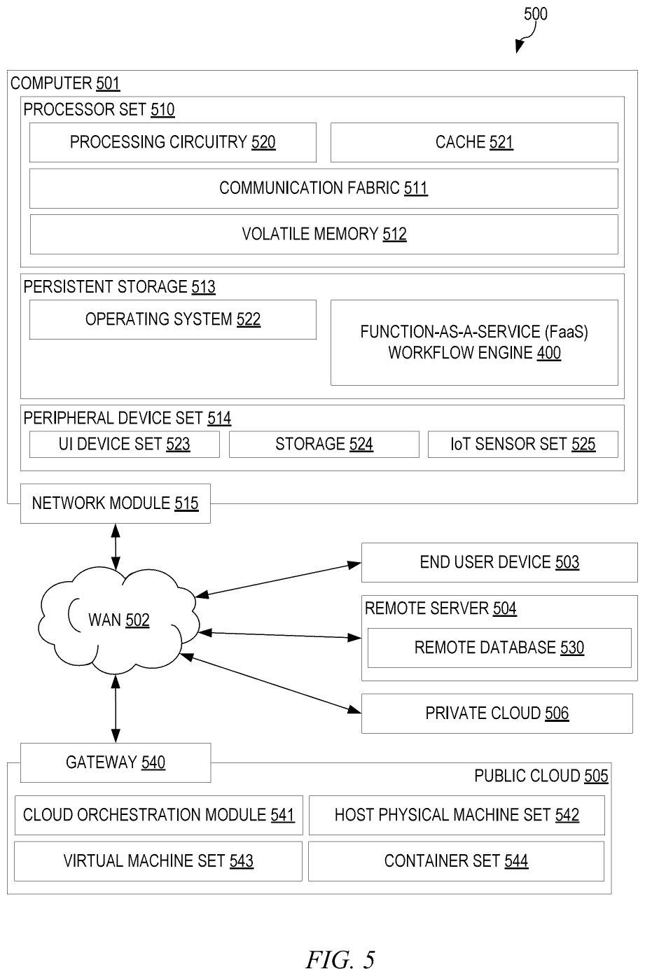

FIG. 5 is an example diagram of a distributed data processing system environment in which aspects of the illustrative embodiments may be implemented and at least some of the computer code involved in performing the inventive methods may be executed. That is, computing environment 500 contains an example of an environment for the execution of at least some of the computer code involved in performing the inventive methods, such as FaaS workflow engine 400. In addition to FaaS workflow engine 400, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and FaaS workflow engine 400, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

Computer 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

Processor set 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in FaaS workflow engine 400 in persistent storage 513.

Communication fabric 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

Persistent storage 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface type operating systems that employ a kernel. The code included in FaaS workflow engine 400 typically includes at least some of the computer code involved in performing the inventive methods.

Peripheral device set 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

Network module 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

Remote server 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

Public cloud 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

As shown in FIG. 5, one or more of the computing devices, e.g., computer 501 or remote server 504, may be specifically configured to implement a FaaS workflow engine 400. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computing device 501 or remote server 504, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates FaaS workflow segmentation and segregation into sub-flows, integration of the sub-flows into separate processes with appropriate insertion of routing taps and proxies to handle inter-process flows, and reconfiguring deployment of the FaaS workflow based on the segmented and segregated sub-flows and process packing.

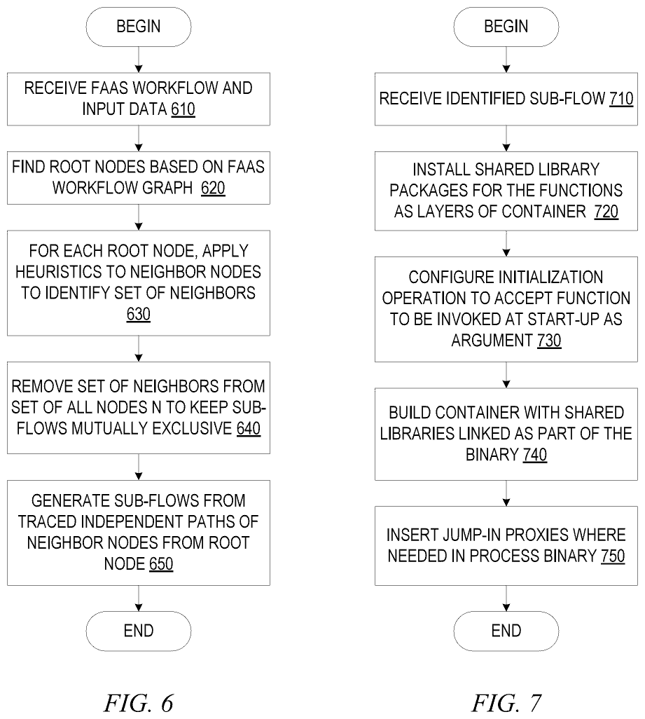

As discussed above with regard to FIG. 4, the FaaS workflow system 400 comprises four main engines 430-460 that operate to implement the improved computer functionality/operations for FaaS workflow segregation, process packing, inter-process routing, and deployment reconfiguration. The operation of each of these engines will now be described in greater detail with regard to FIGS. 6-10.

FIGS. 6-10 present flowcharts outlining example operations of elements of the present invention with regard to one or more illustrative embodiments. It should be appreciated that the operations outlined in FIGS. 6-10 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 6-10, and may, in some cases, make use of the results generated as a consequence of the operations set forth in FIGS. 6-10, the operations in FIGS. 6-10 themselves are specifically performed by the improved computing tool in an automated manner.

FIG. 6 is a flowchart outlining an example operation of a workflow path segregation engine in accordance with one illustrative embodiment. The operation of the workflow path segregation engine is to identify candidate sub-flows within the FaaS workflow such that they can be subsumed as a process. This involves using packing algorithms such as the example strict packing approach on the FaaS workflow graph having node set N, as described hereafter. It should be appreciated that the operation outlined in FIG. 6 is only one example implementation in which a strict packing is performed, and other packing algorithms may be used without departing from the spirit and scope of the present invention. The important aspect is that the mechanisms of the illustrative embodiments identify sequences of function invocations, i.e., sub-flows, that may be packed together into a process, with inter-process invocations being handled by inserted routing taps and proxies.

As shown in FIG. 6, the operation starts by receiving the FaaS workflow, shared libraries of the functions, cluster resources associated with the functions, and cluster state log data (step 610). The FaaS workflow may be represented as a graph data structure that comprises nodes corresponding to the functions invoked as part of the FaaS workflow, with edges connecting the functions representing invocations of functions by other functions in a dependent manner. FIGS. 2-4 show examples of such FaaS workflow graphs. It should be noted that when the FaaS workflow graph is first received, it is not segregated into separate sub-flows and there are no inserted routing taps or proxies.

From the FaaS workflow graph, a set of all nodes with out-degree O in the FaaS workflow graph are identified and the set of such nodes is the root-set R₀ (step 620). For each node r in R₀, one or more heuristics are applied to the neighbor nodes of the root nodes to identify sets of neighbors for each root node (step 630). For example, in some illustrative embodiments, the neighbor nodes, of the root nodes in R₀, that have in-degree I and out-degree of at most X are found. For example, O may be 1, I may be 1, and X may be 2. With X=2, this allows the nodes to have out-going edges that are a self-loop, in addition to another out-going edge. The set of such neighbors is referred to as the set R₁. The out-degree constraint X may be relaxed in some embodiments by choosing neighbors which contain more than one in-degree, but the frequency of invocation from the parent from the on-going exploration is much higher than other parents (dominant invocation heuristic). Another heuristic that may be used in some illustrative embodiments, is correlated scaling of parent and child nodes. High positive correlation between function neighbors, as may be determined from instrumentation mechanisms, e.g., function probes and logs, means that packing them together in a container is advantageous as the scaling of the container will preserve the correlation.

The set of neighbors R₁ is removed from the set of all nodes N to keep the separate sub-flows, or paths, mutually exclusive (step 640). The steps 630-640 are repeated for each neighbor of the root nodes until no further neighbor nodes are in the set R₁. The traced independent paths of neighbors starting from each root node R₀ form the sub-flow candidates with least external branching (step 650). An example of such sub-flow candidates is shown in the previously described FIG. 4. Thus, the operation of FIG. 6 identifies the sub-flows within the FaaS workflow that may be packed into the same process such that the FaaS workflow is segregated into separate processes for separate sub-flows. The operation of the workflow path segregation engine then terminates with regard to this FaaS workflow graph.

FIG. 7 is a flowchart outlining an example operation of a process and invocation apparatus design engine in accordance with one illustrative embodiment. The operation of the process and invocation apparatus design engine is to containerize the processes corresponding to the sub-flows identified by the workflow path segregation engine. The operation packages the sub-flows into containers for separate execution by a corresponding computing system.

As shown in FIG. 7, the operation starts by receiving an identified sub-flow from the workflow path segregation engine (step 710). Based on the identified sub-flow and the input data specifying the libraries for each function of the FaaS workflow, the shared library packages for the functions in the sub-flow are installed as layers of a corresponding container (step 720). The initialization operation of the container for each process is configured to accept as an argument, the function to be invoked at start-up, such that the starting point of the sub-flow may be changed if needed by changing the value for the argument (step 730). The container is built with the shared libraries linked as part of the binary (step 740). A jump-in proxy is inserted into the process binary (step 750). The operation then terminates for the container corresponding to the identified sub-flow, but may be repeated for each sub-flow identified in the FaaS workflow.

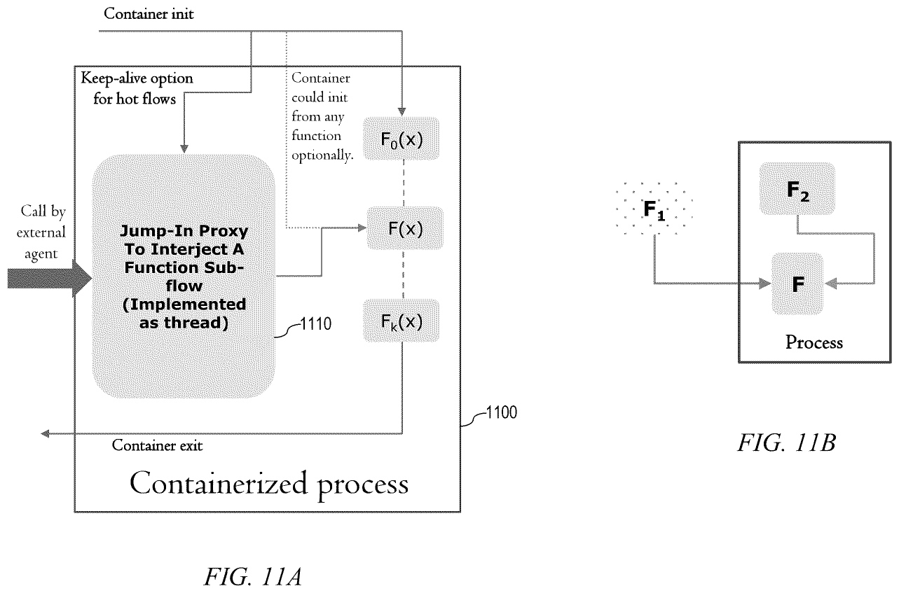

An example depiction of a container for a sub-flow is shown in FIG. 11A. As shown in FIG. 11A, the container 1100 comprises a sequence of functions F0(x), F(x), and Fk(x), where the container initialization operation may initialize the execution of the functions at any function optionally. A jump-in proxy 1110 is provided to interject a function sub-flow for out-of-sequence execution from an external process. The inserted proxy 1110 waits on external function invocation requests and invokes the appropriate packaged function matching the request. This proxy is meant to allow scenarios, such as shown in FIG. 11B, where an external function F1 has to be followed by an invocation of function F, but function F itself is part of the in-process sub-flow F2-F. Hence, F has to be invoked without invoking F2.

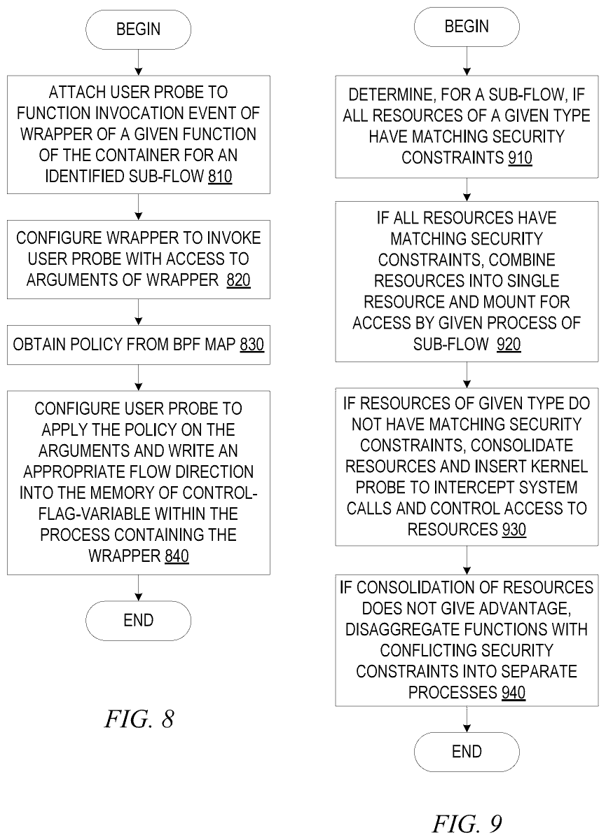

FIG. 8 is a flowchart outlining an example operation of a routing tap design engine in accordance with one illustrative embodiment. The operation of the routing tap design engine is to insert specialized routing taps, using eBPF user probes and their capability to write into user memory space, for example. It should be noted, that the eBPF user probes can be attached at any user-process symbol dynamically even as the process is executing and removed when not necessary. User probes can be attached either to the function call event or return event. User probes have access to the global system state. Functions packed within a process-address space can pass around data with negligible overhead using pointers. Coupled with this advantage and the user probe ability to route call control path, the workflow order is preserved with minimal overhead compared to the overhead of cross-node or cross-process communication.

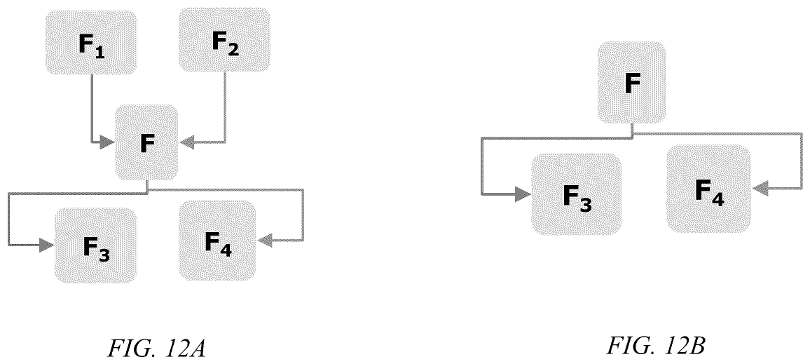

The routing tap for a given function is defined by the workflow topography of the FaaS workflow from the input data. FIGS. 12A and 12B show examples of some of the more common cases that may be handled by an appropriate routing tap. In FIG. 12A, an example is shown in which the control paths flow through a junction. As shown in FIG. 12A, the paths of F1-F-F3 and F2-F-F4 each pass through function F. The routing tap for F has to decide whether to take the first path F1-F-F3 or the second path F2-F-F4. The routing tap, triggered at the time of invocation of function F, can peek into the invocation trace that has occurred so far to control the control flow.

In FIG. 12B, an example is shown in which the control paths are determined as a result of the outcome of the processing performed by function F. That is, in this example, the control paths F-F3 and F-F4 are taken only after F completes its processing. In this case, the user probe attached to the function F return event can peek into the return value of F to determine the control flow.

Returning to FIG. 8, the insertion of a routing tap involves a user probe (in kernel space) being attached to a function invocation event of a wrapper of a given function of the container for an identified sub-flow (step 810). That is, with eBPF, a probe can be attached to an event, which may be a kernel event (called a kprobe) or a user function event (user probe). Even with the user probe, the user probe runs in kernel space, but is attached to a user function.

The wrapper is configured such that when the wrapper function is about to be invoked, the user probe is invoked with access, e.g., from a pt_regs struct, to the arguments of the wrapper, which also contains the arguments of the wrapped function F(x) (step 820). A policy is obtained for configuring the user probe from a BPF map to the user probe (step 830). The BPF map is written into by an eBPF master residing in the user space with access to the cluster state information from the input data. The user probe is configured to apply a policy on the arguments and write an appropriate flow direction into the memory of control-flag-variable within the process containing the wrapper (step 840). The operation terminates for this function, but may be repeated for other functions for which a routing tap is to be inserted.

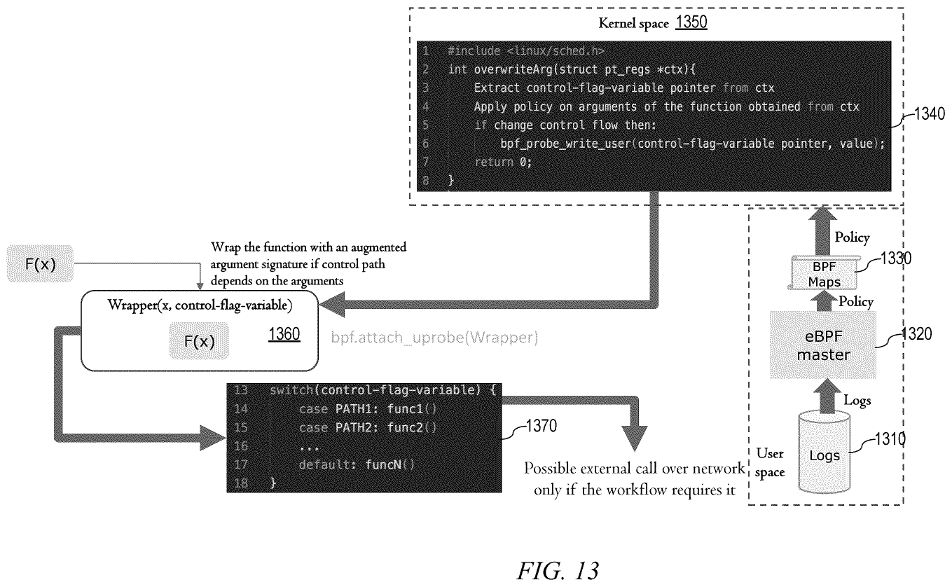

FIG. 13 is an example diagram illustrating the process of FIG. 8 for the example of a routing tap for a function invocation event, such as shown in FIG. 12A. As shown in FIG. 13, the cluster state 1310 provides the logs of the function for which the routing tap is to be inserted. The logs are input to the eBPF master 1320 which accesses the BPF map data structure 1330 that maps the function to a policy. The eBPF master is the kernel program that attaches probes, with the maps being the bridge between the probes and the eBPF master that allows for obtaining data from the probes. The policy is used to configure a user probe 1340 in the kernel space 1350. The function F(x) is wrapped with an augmented argument signature if the control path depends on the arguments. The wrapped function F(x) 1360 is provided with the inserted user probe, bpf.attach_uprobe (Wrapper), where the wrapper executes the policy of the user probe to determine which path to follow 1370. The policy may perform an external call over the network if the FaaS workflow requires it, e.g., in FIG. 4, if the function F(x) is F1, then the routing tap implemented by the wrapper may perform an external call to function F8 or F3 based on the results generated by the execution of the function F1.

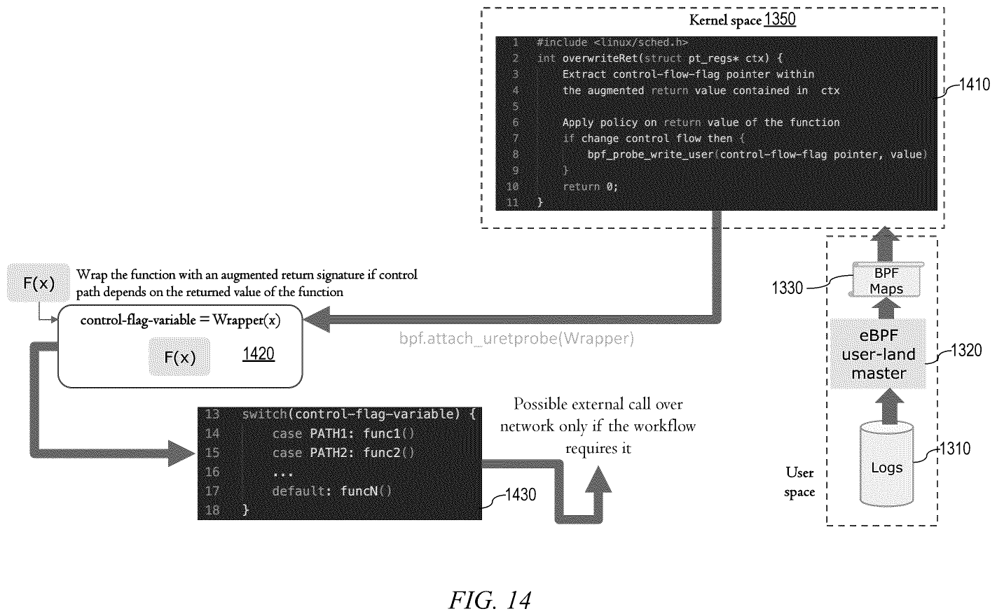

FIG. 14 is an example diagram illustrating the process of FIG. 8 for the example of a routing tap for a function return event, such as shown in FIG. 12B. The example shown in FIG. 14 is similar to FIG. 13, but the policy of the user probe is applied to the return value of the function F(x) as opposed to the arguments of the function obtained from the invocation trace (ctx). Thus, the user probe 1410 applies the policy to the return value of the function and corresponding wrapped functions 1420 and execution to determine paths 1430 is performed.

FIG. 9 is a flowchart outlining an example operation of a deployment reconfiguration engine in accordance with one illustrative embodiment. The operation of the deployment reconfiguration engine is to repackage the resources related to the original functions and reconfigure them to match the new containerized process definitions. Resources can be, for example, storage volumes, ingress, service definitions that include load-balancers, node-ports, cluster-ip services in K8s, configuration maps, secrets, and the like.

As shown in FIG. 9, the operation starts by determining, for a sub-flow, and for all resources of a given type for that sub-flow, if security constraints match for the functions of the sub-flow (step 910). That is, this check determines whether any of the functions of the sub-flow have access to resources of a particular type while other functions of the sub-flow do not have access to those resources. If all of the resources of the given type for the sub-flow have matching security constraints, then the resources may be consolidated into a single larger resource and mounted for access by the given process corresponding to the sub-flow (step 920). If the resources of the given type accessed by the functions of the sub-flow do not have matching constraints, i.e., there are conflicting constraints, then the resources may still be consolidated, but access is controlled by inserting a kernel space probe, e.g., eBPF kprobe, that intercepts system calls, or Linux security module (LSM) hooks, at a fine-grained file descriptor level (step 930). If consolidation does not result in a performance advantage, then the process is disaggregated altogether with the conflicting functions having their own processes (step 940). The operation then terminates, but may be repeated for each separate sub-flow of the FaaS workflow.

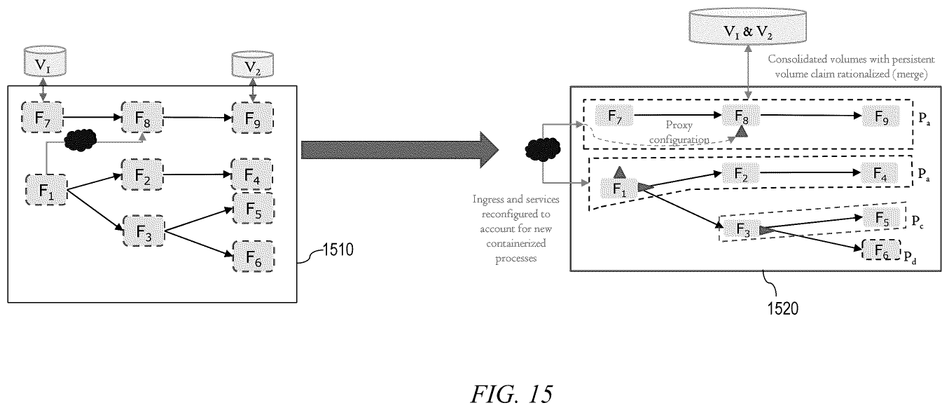

FIG. 15 is an example diagram illustrating the operation of FIG. 9 with regard to the example FaaS workflow of FIG. 4, in accordance with one illustrative embodiment. As shown in FIG. 15, the functions F7 and F9 each access resources V1 and V2, respectively. However, function F7 does not have access to resource V2 and function F9 does not have access to resource V1. Through operation of the illustrative embodiments, the FaaS workflow 1510 is segregated into sub-flows and corresponding processes Pa—Pd as in 1520. According to the reconfiguration deployment operation of FIG. 9, the resources V1 and V2 are consolidated into a single resource V1&V2 accessible by the process Pa. In consolidating the resources V1 and V2, a kernel probe may be inserted to intercept system calls or LSM hooks to access the resource V1&V2 so as to limit access by functions F7 and F9 to their respective resources in accordance with the security constraints.

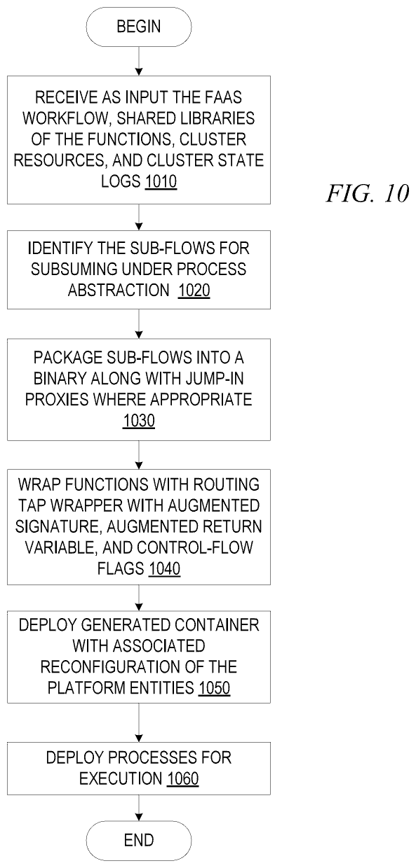

FIG. 10 is a flowchart outlining an example operation of FaaS workflow system in accordance with one illustrative embodiment. The operation outlined in FIG. 10 combines the operations of FIGS. 6-9 to provide the overall operation of the FaaS workflow system for segregating the FaaS workflow into separate sub-flows and corresponding processes that smooth intra-FaaS variations using the process-subsumed sub-flows. As shown in FIG. 10, the operation starts by receiving as input the FaaS workflow, shared libraries of the functions, cluster resources associated with the functions, and cluster state logs (step 1010). The workflow path segregation engine identifies the sub-flows for subsuming under process abstraction, such as by way of a greedy packing algorithm as well as heuristics, such as past scaling patterns of the individual function invocations, as may be determined from logs after the probes have executed for a predetermined amount of time (step 1020). The identified sub-flows are then packaged, by the process and invocation apparatus design engine, into a binary along with jump-in proxies where appropriate, where the binary comprises the libraries for the functions of the sub-flows and the jump-in proxy has a configurable policy that operates to determine a routing of the control flow at the function call or function return (step 1030).

The functions are wrapped, by the routing tap design engine, with a routing tap wrapper with augmented signature which contains the original function signature and control-flow-flats, as well as augmented return variable which contains the return value and the control-flow flags (step 1040). The flags can be set through dynamically attached user probes which get invoked either during function invocation or before the function return. These probes alter the control-flow-flags as per a user-defined policy to alter the ongoing workflow following the function invocation.

The reconfigure deployment engine takes the container created by the previous operations and deploys the container with associated reconfiguration of the platform entities, such as the volumes, ingress/service resources associated with the container, and the like (step 1050). These reconfigurations inherit the original cluster resource definitions associated with the function and rationalize them to be compatible with the contents of the process. The processes, implemented as the separate containers of the sub-flows, may then be deployed for execution (step 1060). The operation then terminates.

Thus, the illustrative embodiments provide an improved computing tool and improved computing tool operations/functionality that identifies sub-flows within a FaaS workflow and packages the sub-flows as separate processes to segregate the FaaS workflow and introduce workflow stability while reducing latency. The illustrative embodiments implement routing taps and proxies which leverage cluster state and the functions' dynamic properties to dynamically control the sub-flows with a process and perform inter-process function invocations.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for segregating a function-as-a-service (FaaS) workflow into processes for segregated execution, the method comprising:
identifying a plurality of sub-flows within the FaaS workflow;
generating, for each sub-flow, a container to implement the sub-flow as a separate process from processes of other sub-flows in the FaaS workflow, wherein at least one sub-flow comprises a plurality of functions of the FaaS workflow; and
deploying the containers of the plurality of sub-flows for execution by one or more nodes.

2. The method of claim 1, wherein the method further comprises inserting, for at least one function, in one or more of the sub-flows of the plurality of sub-flows, that invokes a function of a different sub-flow, a routing tap that applies a policy to alter an input to a subsequent function or determine an execution path based on a condition of the at least one function.

3. The method of claim 2, wherein the routing tap controls, based on an output of a first function in a first sub-flow of a first process, with which the routing tap is associated, which second function in a second sub-flow of a second process to invoke.

4. The method of claim 2, wherein the routing tap comprises logic that determines when to invoke the function of the different sub-flow or to continue a workflow of a sub-flow in which the routing tap is inserted.

5. The method of claim 2, wherein the routing tap comprises a wrapper of the at least one function, which comprises a signature of the at least one function and control-flow-flags, wherein the control-flow-flags are set through an attached probe which is invoked during function invocate or before a function return of the at least one function.

6. The method of claim 2, wherein the routing tap comprises an Extended Berkeley Packet Filter (eBPF) user probe attached to a function invocation event, and wherein the policy is obtained from an eBPF map with an eBPF master.

7. The method of claim 1, wherein the method further comprises inserting a proxy, for at least one function, in the one or more sub-flows of the plurality of sub-flows, that is invoked by a function of a different sub-flow.

8. The method of claim 1, wherein identifying a plurality of sub-flows within the FaaS workflow comprises identifying a subset of functions of the FaaS workflow that are executed together in a sequence at least a threshold number of times.

9. The method of claim 1, wherein the identifying of the plurality of sub-flows within the FaaS workflow is performed dynamically based on gathered performance data for the FaaS workflow, and wherein the sub-flows within the FaaS workflow may change over time based on the gathered performance data.

10. The method of claim 1, wherein deploying the containers of the plurality of sub-flows for execution by one or more nodes comprises generating a deployment plan having segregated invocation paths and control data for the plurality of sub-flows executed as segregated processes.

11. A computer program product comprising a computer readable storage medium having a computer readable program stored therein, wherein the computer readable program, when executed on a computing device, causes the computing device to segregate a function-as-a-service (FaaS) workflow into processes for segregated execution, at least by:
identifying a plurality of sub-flows within the FaaS workflow;
generating, for each sub-flow, a container to implement the sub-flow as a separate process from processes of other sub-flows in the FaaS workflow, wherein at least one sub-flow comprises a plurality of functions of the FaaS workflow; and
deploying the containers of the plurality of sub-flows for execution by one or more nodes.

12. The computer program product of claim 11, wherein the computer readable program further causes the computing device to:
insert, for at least one function, in one or more of the sub-flows of the plurality of sub-flows, that invokes a function of a different sub-flow, a routing tap that applies a policy to alter an input to a subsequent function or determine an execution path based on a condition of the at least one function.

13. The computer program product of claim 12, wherein the routing tap controls, based on an output of a first function in a first sub-flow of a first process, with which the routing tap is associated, which second function in a second sub-flow of a second process to invoke.

14. The computer program product of claim 12, wherein the routing tap comprises logic that determines when to invoke the function of the different sub-flow or to continue a workflow of a sub-flow in which the routing tap is inserted.

15. The computer program product of claim 12, wherein the routing tap comprises a wrapper of the at least one function, which comprises a signature of the at least one function and control-flow-flags, wherein the control-flow-flags are set through an attached probe which is invoked during function invocate or before a function return of the at least one function.

16. The computer program product of claim 12, wherein the routing tap comprises a Extended Berkeley Packet Filter (eBPF) user probe attached to a function invocation event, and wherein the policy is obtained from an eBPF map with an eBPF master.

17. The computer program product of claim 11, wherein the method further comprises inserting a proxy, for at least one function, in the one or more sub-flows of the plurality of sub-flows, that is invoked by a function of a different sub-flow.

18. The computer program product of claim 11, wherein identifying a plurality of sub-flows within the FaaS workflow comprises identifying a subset of functions of the FaaS workflow that are executed together in a sequence at least a threshold number of times.

19. The computer program product of claim 11, wherein the identifying of the plurality of sub-flows within the FaaS workflow is performed dynamically based on gathered performance data for the FaaS workflow, and wherein the sub-flows within the FaaS workflow may change over time based on the gathered performance data.

20. An apparatus comprising:
at least one processor; and
at least one memory coupled to the at least one processor, wherein the at least one memory comprises instructions which, when executed by the at least one processor, cause the at least one processor to segregate a function-as-a-service (FaaS) workflow into processes for segregated execution, at least by:
identifying a plurality of sub-flows within the FaaS workflow;
generating, for each sub-flow, a container to implement the sub-flow as a separate process from processes of other sub-flows in the FaaS workflow, wherein at least one sub-flow comprises a plurality of functions of the FaaS workflow; and
deploying the containers of the plurality of sub-flows for execution by one or more nodes.
